(19) United States
(12) Patent Application Publication
(10) Pub. No.: US 2025/0340764 A1
(43) Pub. Date: Nov. 6, 2025

(54) HOT MELT ADHESIVE COMPOSITIONS INCLUDING A THREE POLYMER BLEND

(71) Applicant: H.B. Fuller Company, St. Paul, MN (US)

(72) Inventors: Ethan A. Gormong, White Bear Lake, MN (US); Daniel A. Everson, Lakeville, MN (US)

(21) Appl. No.: 19/197,095

(22) Filed: May 2, 2025

Related U.S. Application Data
(60) Provisional application No. 63/641,799, filed on May 2, 2024.

(51) Int. Cl. C09J 153/02; C09J 11/08; C09J 123/08; C09J 123/14

(52) U.S. Cl. CPC C09J 153/02; C09J 11/08; C09J 123/08; C09J 123/142

(57) ABSTRACT

This invention is directed to hot melt adhesive compositions useful for forming disposable absorbent articles that include a three polymer blend, have excellent initial bonding performance, and maintain bonding upon aging.

### CROSS REFERENCE TO RELATED APPLICATIONS

This application claims the benefit of U.S. Provisional Application No. 63/641,799, filed May 2, 2024, which is incorporated herein.

### BACKGROUND

Adhesives are often used to bond substrates together to maintain the two substrates in a fixed relation to each other. In the area of industrial adhesives, hot melt adhesives are commonly used to bond together a wide variety of articles including disposable absorbent articles comprising non-woven substrates e.g., adult incontinence products, disposable diapers, sanitary napkins, bed pads, puppy pads, medical dressings, etc.

There can be multiple hot melt adhesives used in the manufacture of a disposable absorbent article. For example, in the manufacture of a disposable diaper or adult incontinence product, hot melt adhesives are used in construction (e.g., bonding the back sheet to the nonwoven and optionally the absorbent pad), elastic attachment (e.g., bonding the elastic material to the back sheet in for example the leg or waist area), for core stabilization (e.g., applying an adhesive to the absorbent core to increase the strength of the core) and as a positioning adhesive.

There is a need for olefin based hot melt adhesive compositions including styrenic block copolymers having improved properties—in particular having improved machinability and further having excellent initial bonding performance that can be maintained upon aging.

### SUMMARY

In one aspect, the invention features a hot melt adhesive composition including from 3% by weight to 15% by weight of a hydrogenated styrenic block copolymer having a styrene content of from 10% by weight to 45% by weight, from 3% by weight to 15% by weight of a propylene polymer, from 3% by weight to 15% by weight of an ethylene polymer, a tackifying agent, and a plasticizer, wherein the hot melt adhesive composition has a Brookfield Viscosity greater than 15,000 cP at 120° C.

In another aspect, the invention features a hot melt adhesive composition including from 3% by weight to 15% by weight of a hydrogenated styrenic block copolymer comprising styrene-ethylene/butylene-styrene having a mid-block with a butylene content of greater than 50% by weight and a styrene content of from 10% by weight to 45% by weight, from 3% by weight to 15% by weight of a propylene polymer, from 3% by weight to 15% by weight of an ethylene polymer, a tackifying agent, and a plasticizer.

In one embodiment, the hot melt adhesive composition has a Brookfield Viscosity at 163° C. of no greater than 14,000 cP, no greater than 10,000 cP or even from 250 cP to 10,000 cP.

In a different embodiment, the propylene polymer and the ethylene polymer are single site catalyzed copolymers. In another embodiment, the hot melt adhesive composition exhibits a 14-day aged Dynamic Peel (coat weight of 3.0 grams per square meter (gsm)) of greater than 0.40 Newton per centimeter (N/cm) when tested according to Peel Adhesion Test Method.

In one embodiment, the propylene polymer is a single-site catalyzed copolymer with ethylene and has an ethylene content of from 12% by weight to 18% by weight. In another embodiment, the propylene polymer and the ethylene polymer have a density of no more than 0.89 grams/cm³, or even no more than 0.88 grams/cm³. In another embodiment, the ethylene polymer and the propylene polymer have an MFI as measured according to ASTM D1238 at 190° C. using a 2.16 kg load of from 5 grams/10 min to 200 grams/10 min, or even 5 grams/10 min to 75 grams/10 min.

In one embodiment, the styrenic block copolymer has a styrene content of from 15% by weight to 30% by weight. In another embodiment, the styrenic block copolymer has an MFI as measured according to ASTM D1238 at 230° C. using a 2.16 kg load of from 5 grams/10 min to 50 grams/10 min. In a different embodiment, the hot melt adhesive composition has a total polymer content of greater than 20% by weight.

In one embodiment, the hot melt adhesive composition includes at least one modified material selected from the group consisting of polymer, tackifying agent and plasticizer. In another embodiment, the hot melt adhesive composition includes a modified polymer selected from the group consisting of propylene polymer and ethylene polymer. In a different embodiment, the modified polymer is grafted with maleic anhydride. In a different embodiment, the propylene polymer is modified. In still another embodiment, the propylene polymer is modified with maleic anhydride. In one embodiment, the hot melt adhesive composition includes from 5% by weight to 12% by weight of the hydrogenated styrenic block copolymer, from 5% by weight to 12% by weight of the propylene polymer, and from 5% by weight to 12% by weight of the ethylene polymer. In a different embodiment, the tackifying agent is a hydrogenated hydrocarbon resin and the plasticizer is a naphthenic oil.

In another aspect, the invention features a hot melt adhesive composition including from 3% by weight to 15% by weight of a hydrogenated styrenic block copolymer comprising styrene-ethylene/butylene-styrene having a mid-block with a butylene content of greater than 50% by weight and a styrene content of from 10% by weight to 45% by weight; from 3% by weight to 15% by weight of a single-site catalyzed propylene ethylene copolymer having an ethylene content of from 12% by weight to 18% by weight and an MFI as measured according to ASTM D1238 at 190° C. using a 2.16 kg load of from 5 grams/10 min to 200 grams/10 min; from 3% by weight to 15% by weight of a single-site catalyzed ethylene copolymer having a density of no more than 0.88 and an MFI as measured according to ASTM D1238 at 190° C. using a 2.16 kg load of from 5 grams/10 min to 200 grams/10 min; a tackifying agent, and a plasticizer.

In one embodiment, the hot melt adhesive composition further includes a wax. In another embodiment, the wax is a semi-crystalline polyethylene wax.

In a different embodiment, the invention includes a disposable absorbent article including the hot melt adhesive composition.

The inventors have discovered olefin polymer based hot melt adhesive compositions including styrenic block copolymers, that have improved properties including improved machinability, improved initial bonding and improved bonding upon aging. Other features and advantages will be apparent from the following description of the preferred embodiments and from the claims.

### GLOSSARY

In reference to the invention, these terms have the meanings set forth below:

The term “ethylene polymer” means a polymer derived from greater than 50% by weight ethylene and optionally an alpha-olefin comonomer.

The term “propylene polymer” means a polymer derived from greater than 50% by weight propylene and optionally ethylene or an alpha-olefin comonomer.

### DETAILED DESCRIPTION

### HOT MELT ADHESIVE COMPOSITION

The invention features a hot melt adhesive composition including from 3% by weight to 15% by weight of a hydrogenated styrenic block copolymer having a styrene content of from 10% by weight to 45% by weight, from 3% by weight to 15% by weight of a propylene polymer, from 3% by weight to 15% by weight of an ethylene polymer, a tackifying agent, and a plasticizer, wherein the hot melt adhesive composition has a Brookfield Viscosity greater than 15,000 cP at 120° C.

The invention also features a hot melt adhesive composition including from 3% by weight to 15% by weight of a hydrogenated styrene-ethylene/butylene-styrene block copolymer having a mid-block with a butylene content of greater than 50% by weight and a styrene content of from 10% by weight to 45% by weight, from 3% by weight to 15% by weight of a propylene polymer, from 3% by weight to 15% by weight of an ethylene polymer, a tackifying agent, and a plasticizer.

The invention further features a hot melt adhesive composition including from 3% by weight to 15% by weight of a hydrogenated styrene-ethylene/butylene-styrene block copolymer, from 3% by weight to 15% by weight of a single-site catalyzed propylene ethylene copolymer having an ethylene content of from 12% by weight to 18% by weight and an MFI as measured according to ASTM D1238 at 190° C. using a 2.16 kg load of from 5 grams/10 min to 200 grams/10 min, from 3% by weight to 15% by weight of a single-site catalyzed ethylene copolymer having a density of no more than 0.88 and an MFI as measured according to ASTM D1238 at 190° C. using a 2.16 kg load of from 5 grams/10 min to 200 grams/10 min, a tackifying agent, and a plasticizer.

The invention further features a hot melt adhesive composition including from 3% by weight to 15% by weight of a hydrogenated styrene-ethylene/butylene-styrene block copolymer having a mid-block with a butylene content of greater than 50% by weight and a styrene content of from 10% by weight to 45% by weight, from 3% by weight to 15% by weight of a single-site catalyzed propylene ethylene copolymer having an ethylene content of from 12% by weight to 18% by weight and an MFI as measured according to ASTM D1238 at 190° C. using a 2.16 kg load of from 5 grams/10 min to 200 grams/10 min, from 3% by weight to 15% by weight of a single-site catalyzed ethylene copolymer having a density of no more than 0.88 and an MFI as measured according to ASTM D1238 at 190° C. using a 2.16 kg load of from 5 grams/10 min to 200 grams/10 min, a tackifying agent, and a plasticizer.

The hot melt adhesive composition can have a Brookfield viscosity of greater than 12,000 cP at 120° C., or even greater than 15,000 cP at 120° C. The inventors have discovered that the use of higher polymer content and/or higher molecular weight polymers (resulting in a higher viscosity) is helpful to get the desired peel performance.

The hot melt adhesive composition preferably has a Brookfield viscosity of no greater than 14,000 centipoise (cP), no greater than 10,000 cP, no greater than 9,000 cP, no greater than 8,000 cP no greater than 7,000 cP, no greater than 6,500 cP, from 250 cP to 14,000 cP, from 250 cP to 10,000 cP, from 250 cP to 9,000 cP, or even from 250 cP to 7000 cP at a temperature of 163° C.

The hot melt adhesive composition preferably has an initial Dynamic Peel (coat weight of 3.0 grams per square meter (gsm)) of greater than 0.45 Newtons per centimeter (N/cm), or even greater than 0.55 N/cm when tested according to Peel Adhesion Test Method.

The hot melt adhesive composition preferably has a 14-day aged Dynamic Peel (coat weight of 3.0 gsm) of greater than 0.40 N/cm, or even greater than 0.55 N/cm when tested according to Peel Adhesion Test Method.

### Polymers

The hot melt adhesive composition includes at least three different polymers. The three polymers include hydrogenated styrenic block copolymer, ethylene polymer and propylene polymer.

Any of the polymers can be present in a modified (e.g., grafted, functionalized, etc.) form. The polymers can be modified with a functional group capable of participating in hydrogen bonding (e.g., organic acid (e.g., carboxylic acid), anhydride (e.g., maleic anhydride), amide, amine, urea, carbamate, hydroxyl, carbonate, ketone, etc.).

The hot melt adhesive composition can include a total polymer content of greater than 20% by weight, greater than 22% by weight, from 12% by weight 15% by weight, 16% by weight, 17% by weight by weight, 18% by weight to 26% by weight, 28% by weight, 30% by weight or any two numbers therebetween.

### Hydrogenated Styrenic Block Copolymer

The hot melt adhesive composition includes a hydrogenated styrenic block copolymer. By hydrogenated it is meant that the majority of the midblock is hydrogenated. The hydrogenated styrenic block copolymer can be in a variety of forms including, e.g., triblock, radial, multiblock, tapered, and combinations thereof. The hydrogenated styrenic block copolymer can be modified with a functional group. The functional group can be grafted within the midblock. The hydrogenated styrenic block copolymer is preferably a triblock copolymer. The styrenic block copolymer can include diblock or can be free of diblock.

The hydrogenated styrenic block copolymer can have a Melt Flow Index (MFI) as tested according to ASTM D1238 at 230° C. utilizing a 2.16 kg load of from 5 grams/10 min, 10 grams/10 min, 12 grams/10 min, 15 grams/10 min to 30 grams/10 min, 50 grams/10 min, 75 grams/10 min, 100 grams/10 minutes, 200 grams/10 minutes, or any two values therebetween.

The hydrogenated styrenic block copolymer can have a styrenic content of from 10% by weight, 12% by weight, 15% by weight to 35% by weight, 40% by weight, 45% by weight, or any two values therebetween. The hydrogenated styrenic block copolymer includes styrene end blocks (A) and at least one midblock (B).

Suitable end blocks (A) include, e.g., styrene, alpha-methylstyrene, o-methylstyrene, m-methylstyrene, p-methylstyrene, p-tert-butylstyrene, 2,4-dimethylstyrene, 2,4,6-trimethylstyrene, and combinations thereof. Useful midblocks include, e.g., elastomeric conjugated dienes (e.g., hydrogenated conjugated dienes), sesquiterpenes (e.g., hydrogenated sesquiterpenes), and combinations thereof.

Suitable midblocks (B) include elastomeric conjugated diene blocks including, e.g., hydrogenated versions of butadiene (e.g., polybutadiene), isoprene (e.g., polyisoprene), 2,3-dimethyl-1,3-butadiene, 1,3-pentadiene, 1,3-hexadiene, and combinations thereof and further including, e.g., ethylene, propylene, butylene, and combinations thereof (e.g., ethylene/butylene and ethylene/propylene). Suitable midblock B sesquiterpenes include, e.g., hydrogenated poly beta farnesene.

A preferred midblock is ethylene/butylene. When the midblock includes ethylene/butylene, it can include greater than 50% by weight, greater than 60% by weight, or even greater than 70% by weight of the butylene. The inventors have discovered that utilizing hydrogenated styrenic block copolymers including a midblock comprising predominately butylene helps improve compatibility between the hydrogenated styrenic block copolymer and the propylene based polymer.

Useful hydrogenated styrenic triblock copolymers include, e.g., styrene-ethylene/butylene-styrene, styrene-ethylene/propylene-styrene, styrene-ethylene/butylene-styrene-styrene, and combinations thereof. Particularly useful hydrogenated styrenic triblock copolymers include styrene-ethylene/butylene-styrene.

Useful hydrogenated styrenic triblock copolymers are commercially available under the KRATON series of trade designations from Kraton Corporation (Houston, Texas) including, e.g., KRATON G 1643, KRATON G1657 and KRATON G1652 and under the VECTOR series of trade designations from TSRC Corporation (Taiwan) including, e.g., VECTOR 8245D.

The hot melt adhesive composition includes from 2% by weight, 3% by weight, 4% by weight, 5% by weight 6% by weight to 9% by weight 10% by weight, 12% by weight, 14% by weight, 16% by weight, 18% by weight, 20% by weight or any two values therebetween of hydrogenated styrenic block copolymer.

### Ethylene Polymer

The hot melt adhesive composition can include one or more ethylene polymers. The ethylene polymer includes greater than 50% by weight ethylene, greater than 60% by weight ethylene, or even greater than 70% by weight ethylene.

The ethylene polymer can be an ethylene/alpha-olefin copolymer. The ethylene polymer can be modified with a functional group. Useful ethylene/alpha-olefin copolymers exhibit a density of no greater than 0.90 g/cm3, no greater than 0.89 g/cm3, or even no greater than 0.88 g/cm3. The ethylene/alpha-olefin copolymer is derived from ethylene and an alpha-olefin co-monomer, e.g., alpha-olefin monomers having at least three carbon atoms, at least four carbon atoms, at least six carbon atoms, at least eight carbon atoms, and combinations of such monomers. Suitable alpha-olefin co-monomers include, e.g., propylene, butene, pentene, hexene, heptene, octene, nonene, decene, dodecane, 4-methyl-pentene-1, 3-methyl pentene-1,3,5,5-trimethyl-hexene-1, 5-ethyl-1-nonene, 1,9-decadiene, and combinations thereof. Specific examples of suitable ethylene/alpha-olefin copolymers include ethylene-propylene, ethylene-butene, ethylene-hexene, ethylene-octene, and combinations thereof.

Useful ethylene polymers can exhibit an MFI as measured according to ASTM D1238A-20 at 190° C. using a 2.16 kg load of 2 grams/10 min, 5 grams/10 min, 10 grams/10 min, 15 grams/10 min to 50 grams/10 min, 75 grams/10 min, 100 grams/10 min, 500 grams/10 min, 1000 grams/10 min, 2000 grams/10 min or any two values there between.

The ethylene polymers can be prepared using a variety of catalysts including, e.g., a single site catalyst e.g., metallocene catalysts, multiple single site catalysts, non-metallocene heteroaryl catalysts, and combinations thereof.

Useful ethylene polymers are commercially available under a variety of trade designations including, e.g., the ENGAGE series of trade designations from The Dow Chemical Company (Midland, Michigan) including ENGAGE 8407 and ENGAGE 8200 single-site catalyzed ethylene/octene copolymers, and the metallocene catalyzed copolymers available under the SABIC series of trade designations from Sabic Innovative Plastics (Riyadh, Saudi Arabia) including, e.g., SABIC FORTIFY C5070D.

The hot melt adhesive composition can include from 3% by weight, from 4% by weight, from 5% by weight from 5.5% by weight, from 6% by weight to 12% by weight, 13% by weight, 14% by weight, 16% by weight, 20% by weight or any two values there between of ethylene polymer.

### Propylene Polymer

The propylene polymer can include one or more propylene polymers. The propylene polymer includes greater than 50% by weight propylene, greater than 60% by weight propylene, greater than 70% by weight propylene, or even greater than 80% by weight propylene.

The propylene polymer can be modified with a functional group. The propylene polymer can be a copolymer. Suitable propylene copolymers are derived from propylene and ethylene or at least one alpha-olefin comonomer examples of which include alpha-olefin comonomers having from four to ten carbon atoms including, e.g., butene, 1,4-methylpentene, hexene, octene, and combinations thereof. In one embodiment, at least one of the propylene-based copolymers, or even both propylene-based copolymers are propylene ethylene copolymers. The propylene-based copolymers can be based entirely on olefins, i.e., do not contain any functional groups. The propylene-based copolymers can include at least 75% by weight propylene or even at least 80% by weight propylene. The propylene-based copolymers can have a polydispersity (Mw/Mn) as tested by size exclusion chromatography (SEC) of less than 5, less than 3, less than 2.5, or even 2.

The propylene polymer can be prepared using a variety of catalysts including, e.g., a single site catalyst e.g., metallocene catalysts, multiple single site catalysts, non-metallocene heteroaryl catalysts, and combinations thereof.

A preferred propylene polymer is a propylene ethylene copolymer having an ethylene content of from 5% by weight, 10% by weight, 12% by weight to 20% by weight, 25% by weight or any two values therebetween.

Useful propylene polymers can exhibit an MFI as measured according to ASTM D1238 at 190° C. using a 2.16 kg load of 2 grams/10 min, 5 grams/10 min, 10 grams/10 min, 15 grams/10 min to 50 grams/10 min, 75 grams/10 min, 100 grams/10 min, 500 grams/10 min, 1000 grams/10 min, 2000 grams/10 min or any two values there between.

Useful propylene polymers include VISTAMAXX 6202 (single site catalyzed propylene ethylene copolymers) commercially available from ExxonMobil Chemical (Houston, Texas) and ACTI-TECH COMPATIBILIZER 16MA11F commercially available from Nordic Grafting Company (Copenhagen).

The hot melt adhesive composition can include from 3% by weight, 4% by weight, 5% by weight, from 5% by weight from 5.5% by weight, from 6% by weight to 10% by weight, 12% by weight, 13% by weight, 14% by weight, 16% by weight, 20% by weight or any two values there between of the propylene polymer.

### Tackifying Agent

The hot melt adhesive composition includes at least one tackifying agent. Preferably the tackifying agent has a softening point at least 90° C., or even at least 100° C. as determined by ASTM E28-58T. Preferred tackifying agents having a softening point greater than 90° C. and have less than 10% by weight aromatic modification and include aliphatic and cycloaliphatic petroleum hydrocarbon tackifying agents, hydrogenated derivatives thereof, and combinations thereof, including, e.g., branched, unbranched, and cyclic C5 resins, C9 resins, and C10 resins, hydrogenated C9 resins, hydrogenated dicyclopentadiene (DCPD), hydrogenated C5 resins, and combinations thereof.

Other suitable classes of tackifying agents include, e.g., mixed aromatic and aliphatic modified hydrocarbon resins, aromatic modified aliphatic hydrocarbon resins, and hydrogenated versions thereof; terpenes, modified terpenes and hydrogenated versions thereof; rosin esters and hydrogenated versions thereof; and combinations thereof.

Examples of useful polyterpene resins include non-hydrogenated polyterpene resins, hydrogenated polyterpene resins, and copolymers and terpolymers of natural terpenes (e.g., styrene-terpene, alpha-methyl styrene-terpene and vinyl toluene-terpene), and combinations thereof.

Useful tackifying agents are commercially available under a variety of trade designations including, e.g., the ESCOREZ series of trade designations from ExxonMobil Chemical Company (Houston, Texas) including, e.g., ESCOREZ 5637 aromatic modified, cycloaliphatic hydrocarbon resin, ESCOREZ 1310LC aliphatic hydrocarbon resin, ESCOREZ 5400 cycloaliphatic hydrocarbon resin, ESCOREZ 5415 cycloaliphatic hydrocarbon resin, ESCOREZ 5600 aromatic modified, cycloaliphatic hydrocarbon resin, ESCOREZ 5615 aromatic modified, cycloaliphatic hydrocarbon resin, and ESCOREZ 5690 aromatic modified, cycloaliphatic hydrocarbon resin, the EASTOTAC series of trade designations from Synthomer Adhesive Resins LLC (Kingsport, Tennessee) including, e.g., EASTOTAC H-100R, EASTOTAC H-100L, and EASTOTAC H130W hydrogenated hydrocarbon resins, the WINGTACK series of trade designations from Cray Valley HSC (Exton, Pennsylvania) including, e.g., WINGTACK 86 aromatically modified, C-5 hydrocarbon resin, WINGTACK EXTRA aromatically modified, C-5 hydrocarbon resin, and

WINGTACK 95 aliphatic C-5 petroleum hydrocarbon resin, the PICCOTAC series of trade designations from Synthomer Adhesive Resins LLC (Kingsport, Tennessee) including, e.g., PICCOTAC 8095 aromatically modified, C-5 hydrocarbon resin and 1115 hydrocarbon resin, the ARKON series of trade designations from Arakawa Europe GmbH (Germany) including, e.g., ARKON P-125 alicyclic saturated hydrocarbon resin, the REGALITE and REGALREZ series of trade designations from Synthomer Adhesive Resins LLC (Kingsport, Tennessee) including, e.g., REGALITE R1125 fully hydrogenated hydrocarbon resin and REGALREZ 1126 hydrocarbon resin, and the RESINALL series of trade designations from Resinall Corp (Severn, North Carolina) including RESINALL R 1030 hydrogenated hydrocarbon resin.

The hot melt adhesive composition can include from 20% by weight, 30% by weight, 35% by weight, 40% by weight, 45% by weight to 55% by weight, 60% by weight, 65% by weight, 70% by weight, or any two values therebetween of tackifying agent.

### Plasticizer

Useful plasticizers include plasticizers that are liquid at room temperature. The term “liquid” as used in reference to the plasticizer means that the plasticizer exhibits a kinematic viscosity of no greater than 5000 centistokes (cS) at 25° C. as determined according to ASTM D445 and a pour point of no greater than 30° C. as determined according to ASTM D97. Useful classes of plasticizers include, e.g., oils, and oligomeric and low molecular weight polymeric plasticizers that are liquid at room temperature. Particularly useful plasticizers include naphthenic oil, paraffinic oil (e.g., cycloparaffin oils), mineral oils, gas to liquid oils, and combinations thereof. The plasticizer can be present in a modified (e.g., grafted) form. The plasticizer can be modified with a functional group capable of participating in hydrogen bonding (e.g., organic acid (e.g., carboxylic acid), anhydride (e.g., maleic anhydride), amide, amine, urea, carbamate, hydroxyl, carbonate, ketone, etc.

Useful plasticizers are commercially available under a variety of trade designations including, e.g., CALSOL 5550 naphthenic oil and DRAKEOL 35 paraffinic oil, from Calumet Specialty Products Partners, LP (Indianapolis, Indiana), and PURETOL 35 paraffinic oil from Petro-Canada Lubricants Inc. (Ontario, Canada), CATENEX T145 paraffinic oil from Shell Oil Products US (Houston, Texas), NYFLEX 223 naphthenic oil from Nynas AB (Stockholm, Sweden), KAYDOL mineral oil from Sonneborn (Tarrytown New York), KRYSTOL 550 mineral oil from Petrochem Carless Limited (Surrey, England), RISELLA X430 natural gas to liquid oil from Shell Oil Products US (Houston, Texas) and LIR 403 and LIR 50 liquid rubber available from Kuraray Company, LTD. (Kashima, Japan).

The hot melt adhesive composition can include from 5% by weight, 10% by weight, 12% by weight, 15% by weight to 25% by weight, 35% by weight, 40% by weight or any two values therebetween of plasticizer.

### Wax

The hot melt adhesive composition can be free of wax or optionally includes wax. Suitable waxes include non-functionalized waxes, modified e.g., functionalized waxes, and combinations thereof. Examples of suitable non-functionalized waxes include paraffin waxes, polyolefin waxes (e.g., polypropylene waxes and polyethylene waxes), Fischer Tropsch waxes, microcrystalline waxes, metallocene waxes, and combinations thereof. The wax can be a semi-crystalline polyethylene wax.

Useful polyethylene waxes are commercially available under a variety of trade designations including, e.g., the EPOLENE series of trade designations from Westlake Chemical Corporation (Houston, Texas) including, e.g., EPOLENE N-21 and N-14 polyethylene waxes, the BARECO series of trade designations from Baker Hughes Inc. (Sugar Land, Texas) including, e.g., BARECO C4040 polyethylene wax, the AC series of trade designations from Honeywell Int'l Inc. (Morristown, New Jersey) including, e.g., A-C 8 and A-C 9 polyethylene waxes, the POLYWAX series of trade designations including POLYWAX 3000 polyethylene wax from Baker Hughes (Houston, Texas), and CWP 400 polyethylene wax from Trecora Chemical (Pasedena, Texas).

Useful polypropylene waxes are commercially available under a variety of trade designations including, e.g., EPOLENE N-15 from Westlake Chemical, HONEYWELL AC1089 from Honeywell Int'l Inc., and LICOCENE 6102 from Clariant Int'l Ltd. (Muttenz, Switzerland).

Useful Fischer Tropsch waxes are commercially available under a variety of trade designations including, e.g., the BARECO series of trade designations from Baker Hughes Inc. (Sugar Land, Texas) including, e.g., BARECO PX-100 and PX-105 Fischer Tropsch waxes, the SHELLWAX series of trade designations from Shell Malaysia Ltd. (Kuala Lumpur, Malaysia) including, e.g., SHELLWAX SX100 and SX105 Fischer Tropsch waxes, the VESTOWAX series of trade designations from Evonik Industries AG (Germany) including, e.g., VESTOWAX 2050 Fischer Tropsch wax, and the SASOLWAX series of trade designations from Sasol Wax North America Corporation (Hayward, California) including, e.g., SASOLWAX H105, C80, H1, and H4 Fischer Tropsch waxes.

Examples of suitable functionalized waxes include functionalized polypropylene wax (e.g., maleated polypropylene wax and oxidized polypropylene wax), functionalized polyethylene wax (e.g., maleated polyethylene wax and oxidized polyethylene wax), polar waxes, functionalized stearamide waxes (e.g., hydroxystearamide, N-(2-hydroxy ethyl)-12-hydroxystearamide, N,N′-ethylene bis 12-hydroxystearamide, and 12-hydroxy stearic acid N,N′-ethylene-bis stearamide), and combinations thereof. Useful commercially available functionalized waxes include, e.g., A-C 597P, A-C 596P, and A-C 1325 maleated polypropylene waxes and A-C 573 maleated polyethylene wax all of which are available from Honeywell Int'l Inc. (Morristown, New Jersey), and EPOLENE E 43 maleated polypropylene wax available from Westlake Chemical Corporation (Houston, Texas).

The hot melt adhesive composition preferably includes less than 10% by weight or less than 5% by weight, from 0% by weight, 0.5% by weight, 1% by weight to 3% by weight, 5% by weight, 10% by weight or any two values therebetween of a wax.

### Additional Components

The hot melt adhesive composition optionally includes additional components including, e.g., additional polymers, fillers, flame retardants and additives (e.g., antioxidants, coextrusion coatings, packaging films, adhesion promoters, ultraviolet light stabilizers, rheology modifiers, biocides, corrosion inhibitors, dehydrators, colorants (e.g., pigments and dyes),) and combinations thereof.

Useful antioxidants include, e.g., pentaerythritol tetrakis[3,(3,5-di-tert-butyl-4-hydroxyphenyl)propionate], 2,2′-methylene bis(4-methyl-6-tert-butylphenol), phosphites including, e.g., tris-(p-nonylphenyl)-phosphite (TNPP) and bis(2,4-di-tert-butylphenyl)4,4′-diphenylene-diphosphonite, di-stearyl-3,3′-thiodipropionate (DSTDP), and combinations thereof. Suitable antioxidants are commercially available under a variety of trade designations including, e.g., the IRGANOX series of trade designations including, e.g., IRGANOX 1010, IRGANOX 565, and IRGANOX 1076 hindered phenolic antioxidants, and IRGAFOS 168 phosphite antioxidant, all of which are available from BASF Corporation (Florham Park, New Jersey), and ETHYL 702 4,4′-methylene bis(2,6-di-tert-butylphenol). When present, the adhesive composition preferably includes from about 0.1% by weight to 2% by weight antioxidant.

### USES

The hot melt adhesive composition is useful in a variety of forms including, e.g., as a coating (e.g., continuous coatings and discontinuous coatings (e.g., random, pattern, and array)), bead, film (e.g., continuous films and discontinuous films), fibers, and combinations thereof.

The hot melt adhesive composition can be applied to or incorporated in a variety of substrates and articles including, e.g., woven and nonwoven webs (e.g., webs made from fibers (e.g., yarn, thread, filaments, microfibers, blown fibers, and spun fibers) and nonwoven polypropylene webs), films (e.g., polyolefin films (e.g., polypropylene and polyethylene films), nylon, rayon, polyester, polyvinyl chloride, polyurethane, and combinations thereof), perforated films, tape backings, fibers, substrates made from fibers (e.g., synthetic polymer fibers (e.g., nylon, rayon, polyesters, acrylics, polypropylenes, polyethylene, polyvinyl chloride, and polyurethane synthetic polymer fibers), virgin fibers, recycled fibers, cellulose fibers (e.g., natural cellulose fibers such as wood pulp), natural fibers (e.g., cotton, silk and wool), fibers made from natural materials including, e.g., polylactic acid, and glass fibers, and combinations thereof)), release liners, porous substrates, sheets (e.g., paper, and fiber sheets), paper products, labels (e.g., paper and polypropylene labels), substrates used in disposable absorbent articles.

The hot melt adhesive composition can be used to form disposable absorbent articles including e.g., diapers, feminine hygiene articles (e.g., sanitary napkins), adult incontinence articles, meat pads, medical gowns and combinations thereof.

Formulations of the hot melt adhesive composition are useful as a construction adhesive to bond polymer films (e.g., disposable absorbent articles) to a nonwoven substrate, to bond two nonwoven substrates together, and combinations thereof.

Formulations of the hot melt adhesive composition are useful as a core adhesive to fix the location of the absorbent material (e.g., fluff, superabsorbent polymer, and combinations thereof) during manufacture and use of the disposable absorbent article.

Formulations of the hot melt adhesive composition are useful as an elastic attachment adhesive to bond elastic strands to polyethylene or polypropylene films and nonwoven substrates.

Formulations of the hot melt adhesive composition are useful as a positioning adhesive to enable positioning of a feminine hygiene product such as a sanitary napkin or pantyliner on an article of clothing, which can be made from a variety of materials including, e.g., cotton, synthetic microfiber, nylon, and combinations thereof.

The hot melt adhesive composition can be applied using any suitable application method including, e.g., slot coating, spraying, spray coating (e.g., spiral spray, random spraying, and random fiberization (e.g., melt blowing), foaming, extrusion (e.g., applying a bead, fine line extrusion, single screw extrusion, and twin screw extrusion), wheel application, noncontact coating, contacting coating, gravure, engraved roller, roll coating, transfer coating, screen printing, flexographic, “on demand” application methods, and combinations thereof. In on demand hot melt application systems (which are also referred to as “tank free” and “tankless” systems), hot melt compositions are fed in a solid state (e.g., pellets), to a relatively small heating vessel (relative to traditional hot melt applications systems that include a pot) where the hot melt composition is melted and, typically shortly thereafter, the molten liquid is applied to a substrate.

The invention will now be described by way of the following examples. All parts, ratios, percentages, and amounts stated in the Examples are by weight unless otherwise specified.

### EXAMPLES

### Test Procedures

Test procedures used in the examples include the following. All ratios and percentages are by weight unless otherwise indicated. The procedures are conducted at room temperature (i.e., an ambient temperature of from about 20° C. to about 23° C.) unless otherwise specified.

### Brookfield Viscosity Test Method

The viscosity of the hot melt adhesive composition is determined in accordance with ASTM D-3236 entitled, “Standard Test Method for Apparent Viscosity of Hot Melt Adhesives and Coating Materials,” (Oct. 31, 1988) using a Brookfield Thermosel Viscometer Model RVDV 2+ and spindle number 27. The results are reported in centipoise (“cP”).

### Peel Test Sample Preparation

A slot coating applicator, which is 3 inch (in) (76.2 millimeter (mm)) wide, and a laminator are set to an application temperature of 163° C., without a bonding roll or end seal unit, using an application coat weight of either 1.5 or 3 grams (g)/square meter (m2), and minimal rewind and unwind tensions so as not to stretch the web.

The hot melt adhesive composition is applied continuously on a polypropylene nonwoven web having a thickness of 0.1 mm and a basis weight of 15 g/m2. The nonwoven web is passed through the applicator at a speed of from 190 meters per minute (m/min) to 250 m/min with 5 mm deflection. A non-breathable, layered polyethylene film having a thickness of 0.23 mm, traveling at the same speed as the nonwoven web, is then adhered into place against the adhesive composition and the nonwoven web to form a laminate. The time between coating the adhesive to the nonwoven and adhering to the polyethylene film is 0.3-0.4 seconds.

Accelerated aging of laminates was performed in a 49° C. oven at the time listed in Table 2.

### Dynamic Peel Adhesion Test Method

Dynamic Peel is determined according to ASTM D1876-01 entitled, “Test Method for Determining Peel Resistance of Adhesive (T-Peel Test Method),” with the exception that 8 replicates are run. The test samples are run on an IMASS Spec-type test instrument. The test samples are prepared as described in the Peel Test Sample Preparation-Type II. Eight test samples are prepared for each sample composition, and the test samples are tested 24 hours after the test sample has been prepared. The average peel value over 10 seconds of peeling is recorded, and the results are reported in units of Newtons per centimeter (N/cm)

Hot melt adhesive compositions found below were prepared by combining and mixing the components under nitrogen in the amounts set forth in Table 2 in a sigma blade mixer operating at 177° C.

The hot melt adhesive compositions were then tested according to the Brookfield Viscosity and Dynamic Peel Adhesion test methods. The hot melt adhesive compositions and the results can be found below in Table 2.

TABLE 1
Polymer Properties

| | Melt Flow Index | | | | Melt Index | |
|---|---|---|---|---|---|---|
| | ASTM D 1238 | Styrene | Diblock | | ASTM D 1238 | |
| | (230° C., 2.16 kg) | Content | Content | Density | (190° C., 2.16 kg) | Ethylene |
| | grams/10 min | (weight %) | (weight %) | (grams/cm³) | grams/10 min | Content |
| KRATON G 1643 | 20 (2.16 kg) | 20 | 0 | | | |
| (enhanced rubber | | | | | | |
| segment) | | | | | | |
| KRATON G1657 | 22 (5 kg) | 13 | 30 | | | |
| KRATON G1652 | 6 (5 kg) | 29 | 0 | | | |
| VISTAMAXX 6202 | | | | 0.862 | 9.1 | 15 |
| ACTI-TECH | | | | 0.89 | 50 | 15 |
| COMPATIBILIZER | | | | | | |
| 16MA11F (maleic | | | | | | |
| anhydride modified) | | | | | | |
| ENGAGE 8407 | | | | 0.870 | 30 | |

TABLE 2
Examples

| | COMP | COMP | | | | | | | | | | |
|---|---|---|---|---|---|---|---|---|---|---|---|---|
| | 1 | 2 | EX 1 | EX 2 | EX 3 | EX 4 | EX 5 | EX6 | EX 7 | EX 8 | EX 9 | EX 10 |
| KRATON G1643 | 12 | 12 | | | | 8 | 6 | 4 | 4 | 8 | 8 | 7 |
| KRATON G1657 | | | | 8 | 4 | | | | | | | |
| KRATON G1652 | | | 4 | | | | | | | | | |
| VISTAMAXX 6202 | 12 | | 8 | 8 | 8 | 8 | 8 | 8 | 4 | 5 | 5 | 8 |
| ACTI-TECH | | | | | | | | | 4 | 3 | 3 | |
| COMPATIBILIZER | | | | | | | | | | | | |
| 16MA11F | | | | | | | | | | | | |
| ENGAGE 8407 | | 12 | 12 | 8 | 12 | 8 | 10 | 9 | 10 | 8 | 8 | 8 |
| KURARAY LIR-403 | | | | | | | | 3 | | | | |
| ESCOREZ 5400 | 54 | 54 | 54 | 54 | 54 | 54 | 54 | 54 | 55 | 54 | 54 | 56 |
| CALSOL 5550 | 20 | 20 | 20 | 20 | 20 | 20 | 20 | 20 | 21 | 20 | 10 | 20 |
| PURETOL 35 | | | | | | | | | | | 10 | |
| ADDITIVES | 2.0 | 2.0 | 2.0 | 2.0 | 2.0 | 2.0 | 2.0 | 2.0 | 2.0 | 2.0 | 2.0 | 2.0 |
| Viscosity @ 163° C. (cP) | 8125 | 3955 | 10700 | 13280 | 12480 | 7263 | 8750 | 7900 | 5300 | 6717 | 6075 | 6550 |
| Dynamic Peel (N/cm) | | | | | | | | | | | | |
| (1.5 gsm coat wt.) | | | | | | | | | | | | |
| Initial | 0.17 | 0.15 | 0.16 | 0.21 | 0.23 | 0.19 | 0.21 | 0.26 | 0.17 | 0.19 | 0.18 | 0.19 |
| 14-day Aged | 0.11 | 0.05 | 0.11 | 0.11 | 0.15 | 0.11 | 0.11 | 0.15 | 0.26 | 0.18 | 0.19 | 0.11 |
| 28-day Aged | 0.13 | 0.07 | 0.12 | 0.11 | 0.14 | 0.10 | 0.07 | 0.14 | 0.21 | 0.17 | 0.14 | 0.12 |
| Dynamic Peel (N/cm) | | | | | | | | | | | | |
| (3 gsm coat wt.) | | | | | | | | | | | | |
| Initial | 0.56 | 0.46 | 0.53 | 0.62 | 0.80 | 0.73 | 0.72 | 0.71 | 0.5 | 0.63 | 0.53 | 0.67 |
| 14-day Aged | 0.26 | 0.11 | 0.52 | 0.57 | 0.61 | 0.65 | 0.56 | 0.54 | 0.79 | 0.58 | 0.49 | 0.59 |
| 28-day Aged | 0.29 | 0.12 | 0.45 | 0.49 | 0.58 | 0.56 | 0.41 | 0.51 | 0.57 | 0.55 | 0.53 | 0.56 |

What is claimed is:

1. A hot melt adhesive composition comprising:
a. from 3% by weight to 15% by weight of a hydrogenated styrenic block copolymer having a styrene content of from 10% by weight to 45% by weight,
b. from 3% by weight to 15% by weight of a propylene polymer,
c. from 3% by weight to 15% by weight of an ethylene polymer,
d. a tackifying agent, and
e. a plasticizer,
wherein the hot melt adhesive composition has a Brookfield Viscosity greater than 15,000 cP at 120° C.

2. The hot melt adhesive composition of claim 1 wherein the hydrogenated styrenic block copolymer comprises styrene-ethylene/butylene-styrene having a mid-block with a butylene content of greater than 50% by weight and a styrene content of from 10% by weight to 45% by weight.

3. The hot melt adhesive composition of claim 1 having a Brookfield Viscosity at 163° C. of no greater than 10,000 cP.

4. The hot melt adhesive composition of claim 1 wherein the propylene polymer and the ethylene polymer are single site catalyzed copolymers.

5. The hot melt adhesive composition of claim 1 exhibiting a 14-day aged Dynamic Peel (coat weight of 3.0 grams per square meter (gsm)) of greater than 0.40 Newton per centimeter (N/cm) when tested according to Peel Adhesion Test Method.

6. The hot melt adhesive composition of claim 1 wherein the propylene polymer is a single-site catalyzed copolymer with ethylene and has an ethylene content of from 12% by weight to 18% by weight.

7. The hot melt adhesive composition of claim 1 wherein the propylene polymer and the ethylene polymer have a density of no more than 0.89 grams/cm³.

8. The hot melt adhesive composition of claim 1 wherein the propylene polymer and the ethylene polymer have a density of no more than 0.88 grams/cm³.

9. The hot melt adhesive composition of claim 1 wherein the ethylene polymer and the propylene polymer have an MFI as measured according to ASTM D1238 at 190° C. using a 2.16 kg load of from 5 grams/10 min to 200 grams/10 min.

10. The hot melt adhesive composition of claim 1 wherein the ethylene polymer and the propylene polymer have an MFI as measured according to ASTM D1238 at 190° C. using a 2.16 kg load of from 5 grams/10 min to 75 grams/10 min.

11. The hot melt adhesive composition of claim 1 wherein the styrenic block copolymer has a styrene content of from 15% by weight to 30% by weight and a MFI as measured according to ASTM D1238 at 230° C. using a 2.16 kg load of from 5 grams/10 min to 50 grams/10 min.

12. The hot melt adhesive composition of claim 1 having a total polymer content of greater than 20% by weight.

13. The hot melt adhesive composition of claim 1 comprising at least one modified material selected from the group consisting of polymer, tackifying agent and plasticizer.

14. The hot melt adhesive composition of claim 1 including a modified polymer selected from the group consisting of propylene polymer and ethylene polymer.

15. The hot melt adhesive composition of claim 14 wherein the modified polymer is grafted with maleic anhydride.

16. The hot melt adhesive composition claim 1 comprising:
a. from 5% by weight to 12% by weight of the hydrogenated styrenic block copolymer,
b. from 5% by weight to 12% by weight of the propylene polymer, and
c. from 5% by weight to 12% by weight of the ethylene polymer.

17. The hot melt adhesive composition of claim 1 wherein the tackifying agent is a hydrogenated hydrocarbon resin and the plasticizer is a naphthenic oil.

18. The hot melt adhesive composition of claim 1 further comprising from 1% by weight to 5% by weight of a wax.

19. A hot melt adhesive composition comprising:
a. from 3% by weight to 15% by weight of a hydrogenated styrenic block copolymer comprising styrene-ethylene/butylene-styrene having a mid-block with a butylene content of greater than 50% by weight and a styrene content of from 10% by weight to 45% by weight,
b. from 3% by weight to 15% by weight of a single-site catalyzed propylene ethylene copolymer having an ethylene content of from 12% by weight to 18% by weight and an MFI as measured according to ASTM D1238 at 190° C. using a 2.16 kg load of from 5 grams/10 min to 200 grams/10 min
c. from 3% by weight to 15% by weight of a single-site catalyzed ethylene copolymer having a density of no more than 0.88 and an MFI as measured according to ASTM D1238 at 190° C. using a 2.16 kg load of from 5 grams/10 min to 200 grams/10 min
d. a tackifying agent, and
e. a plasticizer.

20. A disposable absorbent article comprising the hot melt adhesive composition claim 1.
